(19) United States
(12) Patent Application Publication
(10) Pub. No.: US 2026/0236250 A1
(43) Pub. Date: Aug. 13, 2026

(54) PARALLEL FPGA FIRMWARE UPDATING

(71) Applicant: INTERNATIONAL BUSINESS MACHINES CORPORATION, ARMONK, NY (US)

(72) Inventors: Todd C. Sorenson, Tucson, AZ (US); Gary William Batchelor, Tucson, AZ (US); Louis A. Rasor, Tucson, AZ (US); Matthew D. Carson, Encino, CA (US)

(21) Appl. No.: 19/052,493

(22) Filed: Feb. 13, 2025

(51) Int. Cl. G06F 8/654

(52) U.S. Cl. CPC G06F 8/654

(57) ABSTRACT

One or more computer processors allocating, by a firmware update manager, system memory for one or more firmware images based on respective firmware image size. The one or more computer processors read, by the firmware update manager, the one or more firmware images into the allocated system memory. The one or more computer processors input/output (IO) map, by the firmware update manager, each firmware image from the allocated system memory such that peripheral component interconnect express (PCIe) devices have direct memory access (DMA) to each of the one or more firmware images. The one or more computer processors transmit, by the firmware update manager, a PCIe address and a firmware image size to one or more respective field-programmable gate arrays (FPGAs). The one or more computer processors update the one or more respective FPGAs with the one or more firmware images utilizing the respective PCIe address.

### STATEMENT REGARDING PRIOR DISCLOSURES BY THE INVENTOR OR A JOINT INVENTOR

The following disclosure(s) are submitted under 35 U.S.C. 102(b)(1)(A):

(i) 10th Generation IBM DS8000 Enterprise Storage System; Todd C. Sorenson, Gary William Batchelor, Louis A. Rasor, and Matthew D. Carson; 10/25/2024.

### BACKGROUND

The invention relates generally to the field of field-programmable gate array, and more particularly to field-programmable gate array firmware updating.

Firmware is software that provides low-level control of computing device hardware. For a relatively simple device, firmware may perform all control, monitoring and data manipulation functionality. For a more complex device, firmware may provide relatively low-level control as well as hardware abstraction services to higher-level software such as an operating system.

A field-programmable gate array (FPGA) is a type of configurable integrated circuit that can be repeatedly programmed after manufacturing. FPGAs are a subset of logic devices referred to as programmable logic devices (PLDs). FPGAs consist of an array of programmable logic blocks with a connecting grid which can be configured to interconnect with other logic blocks to perform various digital functions. The logic blocks of an FPGA can be configured to perform complex combinational functions, or act as simple logic gates like AND and XOR. In most FPGAs, logic blocks also include memory elements, which may be simple flip-flops or more sophisticated blocks of memory. Many FPGAs can be reprogrammed to implement different logic functions, allowing flexible reconfigurable computing as performed in computer software.

Embodiments of the invention disclose a computer-implemented method, a computer program product, and a system. The computer-implemented method includes one or more computer processers allocating, by a firmware update manager, system memory for one or more firmware images based on respective firmware image size. The one or more computer processors read, by the firmware update manager, the one or more firmware images into the allocated system memory. The one or more computer processors input/output (IO) map, by the firmware update manager, each firmware image from the allocated system memory such that peripheral component interconnect express (PCIe) devices have direct memory access (DMA) to each of the one or more firmware images. The one or more computer processors transmit, by the firmware update manager, a PCIe address and a firmware image size to one or more respective field-programmable gate arrays (FPGAs). The one or more computer processors update the one or more respective FPGAs with the one or more firmware images utilizing the respective PCIe address.

### BRIEF DESCRIPTION OF THE DRAWINGS

FIG. 1 is a functional block diagram illustrating a computing environment, in accordance with an embodiment of the invention;

FIG. 2 is a flowchart depicting operational steps of a program, on a firmware update manager within the computing environment of FIG. 1, for controlling field-programmable gate array firmware updates, in accordance with an embodiment of the invention;

FIG. 3 is a flowchart depicting operational steps of the program, on a field-programmable gate array within the computing environment of FIG. 1, for updating firmware, in accordance with an embodiment of the invention; and

FIG. 4 illustrates operational steps of the program within the computing environment of FIG. 1, in accordance with an embodiment of the invention.

### DETAILED DESCRIPTION

Electronic device vendors, distributors, and companies are often limited to a subset of electronic parts and devices due to commodity (e.g., FPGAs) limitations imposed by environmental, trade, and production restrictions. Often, said companies attempt to utilize alternative electronics to fulfill their needs. For example, replacing a specific FPGA with another with comparable features. Organizations without flexibility to allow on demand firmware updates of varying types of FPGAs, within a process or system, prevent the efficient utilization of comparable FPGAs. Current FPGA updating and provisioning systems are wholly inadequate to replace an entire system or product line comprising of hundreds or thousands of FPGAs. Current provisioning systems update and provision FPGA in a sequential fashion, requiring the system to complete a FPGA firmware update before commencing on another FPGA. Current solutions sequentially load each firmware image to each corresponding FPGA device, which extends the firmware update process by the number of different types of FPGAs in the system. Current provisioning systems are computationally inefficient and require significant computational resources for extended periods of time compounded by the number of FPGAs that are updating.

Embodiments of the invention allow for parallel, on demand FPGA provisioning and firmware updating through a centralized direct memory access system of firmware images mapped to a plurality of typed FPGAs. Embodiments of the invention allow for multiple FPGAs to update from a subset of available firmware images without needing to wait for the completion of other FPGAs. Some embodiments of the invention recognize that computational resources are conserved and made more efficient as FPGAs are quickly provisioned and the computational resources become available for other computational processes and applications.

Implementation of embodiments of the invention may take a variety of forms, and exemplary implementation details are discussed subsequently with reference to the Figures.

The invention will now be described in detail with reference to the Figures.

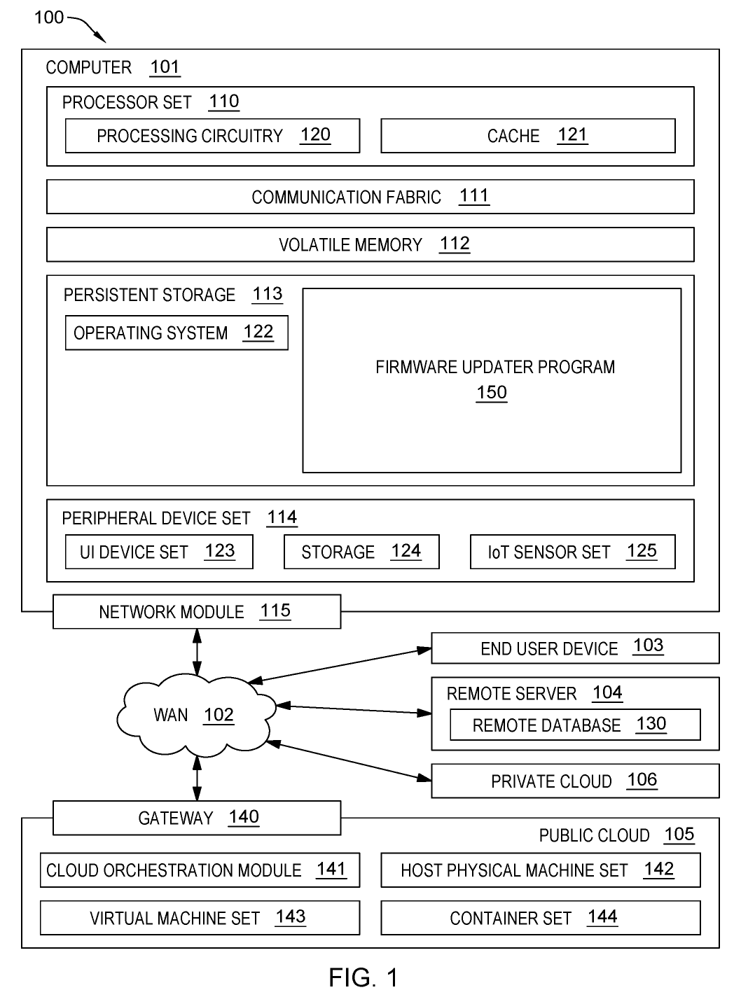

FIG. 1 depicts computing environment 100 illustrating components of computer 101 in accordance with an illustrative embodiment of the invention. It should be appreciated that FIG. 1 provides only an illustration of one implementation and does not imply any limitations with regard to the environments in which different embodiments may be implemented. Many modifications to the depicted environment may be made.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

Computing environment 100 contains an example of an environment for the execution of at least some of the computer code involved in performing the inventive methods, such firmware updater program 150, hereinafter referred to as program 150. In addition to program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, container set 144, firmware images 152, and field-programmable gate array (FPGA) 154a-c.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip”. In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in program 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

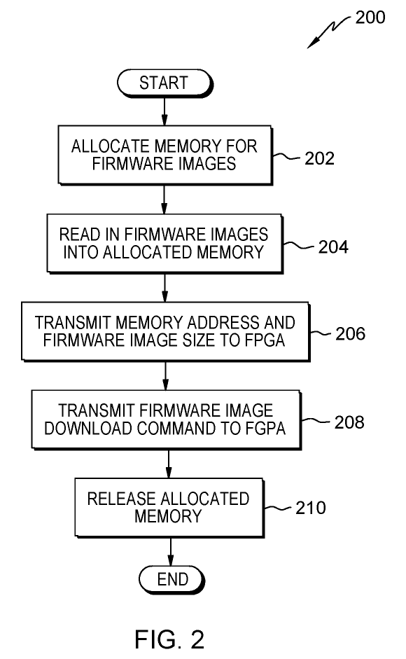

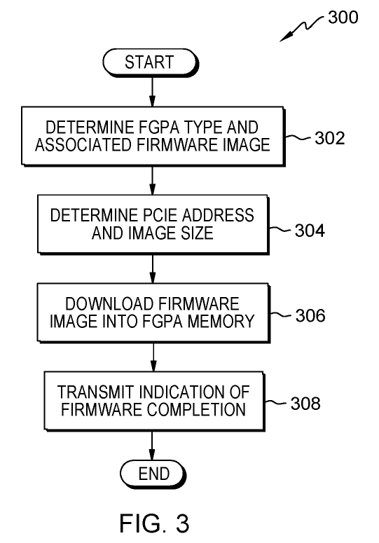

Program 150 is a program, a subprogram of a larger program, an application, a plurality of applications, or mobile application software, which functions to update firmware associated with a plurality of FPGAs, parallel. In various embodiments, program 150 may implement the following steps: allocating, by a firmware update manager, system memory for one or more firmware images based on respective firmware image size; reading, by the firmware update manager, the one or more firmware images into the allocated system memory; mapping, by the firmware update manager, each firmware image from the allocated system memory such that peripheral component interconnect express (PCIe) devices have direct memory access (DMA) to each of the one or more firmware images; transmitting, by the firmware update manager, a PCIe address and a firmware image size to one or more respective field-programmable gate arrays (FPGAs); and updating the one or more respective FPGAs with the one or more firmware images utilizing the respective PCIe address. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over WAN 102. In various embodiments, client versions of program 150 resides on any other computing device (not depicted) within computing environment 100. In the depicted embodiment, program 150. Program 150 is depicted and described in further detail with respect to FIGS. 2 and 3.

Firmware images 152 comprise one or more firmware images utilized to update FPGA 154a-c, while three FPGAs are depicted, there may be any number of FPGAs. In an embodiment, the firmware image combines a bootloader, FPGA bitstream, and application software/operating system (OS). In an embodiment, the bitstream is loaded into the FPGA by the bootloader. In another embodiment, firmware images 152 contain specific FPGA-based functions, as well as the interconnects between those functions, are described in a hardware description language (HDL). In an embodiment, program 150 compiles the description produce an FPGA configuration file. In another embodiment, program 150 uses the HDL and built-in FPGA resources (e.g., memory arrays, PCI cores to create customized logic circuits (e.g., adders, multiplexers and other application-specific functions) from FPGA elements.

Field-programmable gate arrays (FPGA) 154a-c comprise a plurality of FPGAs that may be configured and reconfigured for any potential application. In an embodiment, FPGA 154a-c comprises a plurality of different FPGAs with distinct types, builds, and configurations. FPGA 154a-c contain circuit elements arranged in a fixed structure (programmable logic blocks) with reconfigurable interconnects. In an embodiment, FPGA 154a-c respectively comprise programmable logic blocks that are logic blocks formed from thousands of transistors to millions of transistors. Programmable logic blocks implement the logic functions required by the design and consist of logic components such as transistor pairs, look-up tables (LUTs), and Carry and Control Logic (flip flops and multiplexers). In another embodiment, FPGA 154a-c respectively comprise programmable interconnect resources that are electrically programmable interconnections (pre-laid vertically and horizontally) and provide the routing path for the programmable logic blocks. In an embodiment, FPGA 154a-c may respectively be any combination of the following: antifuse-based FPGA (i.e., one-time programmable element called an antifuse configured by applying a high voltage to create connections between internal wires), SRAM-based FPGA (i.e., configured at run time with static random-access memory (SRAM) to store configuration instructions and require external memory to hold the configuration code), flash-based FPGAs (i.e., store configuration in nonvolatile flash memory with a benefit of being reprogrammable), EEPROM-based FPGA (i.e., electronically erasable programmable read-only memory (EEPROM) stores the configuration), hybrid FPGA (i.e., a combination of different programmable elements, such as SRAM- or flash-based logic blocks), and system-on-chip FPGA (i.e., integrates programmable logic with hard processor cores, combining the functionality of both an FPGA and an SoC, a single silicon chip that combines multiple system processing chips like CPUs, GPUs and RAM into one unit).

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

FIG. 2 depicts flowchart 200 illustrating operational steps of program 150 for controlling field-programmable gate array firmware updates on a firmware update manager, in accordance with an embodiment of the invention. The steps contained in FIG. 2 are executed on a firmware update manager.

Program 150 allocates memory for firmware images (step 202). In an embodiment, program 150 initiates responsive to program 150 receiving, storing, and/or compiling firmware images 152 within a filesystem associated with an operating system. In another embodiment, program 150 initiates responsive to one or more detected changes within firmware images 152 (e.g., an upgraded or downgraded firmware image). In an embodiment, responsive to firmware images 152, program 150 allocates system memory or a memory space for each respective firmware image based on respective firmware image size, where each firmware image is independently and directly accessible in memory. In an embodiment, program 150 indicates to an operating system, control system, or structure that the allocated memory is in use for a subsequent firmware download. In an embodiment, program 150 receives a user indication that a specific type or brand of FPGA, and an associated firmware image, is in limited quantities. Responsively, program 150 identifies one or more similar (i.e., similar features or structural elements) FPGAs and modifies the associated firmware image to conform with the identified FPGAs.

Program 150 reads in firmware images into the allocated memory (step 204). In an embodiment, responsive to the allocated memory, program 150 reads in or stores firmware images 152 into respective allocated memory portions. In another embodiment, responsive to program 150 reading in firmware images 152, program 150 input/output (IO) maps each respective firmware image, such that peripheral component interconnect express (PCIe) devices have direct memory access (DMA) to firmware images 152. In an embodiment, program 150 maintains a dynamic list of each firmware image with associated system memory address, PCIe address, and firmware image size.

Program 150 transmits memory address and firmware image size to field-programmable gate array (FPGA) (step 206). In an embodiment, program 150, continuously, transmits at least a portion of the maintained dynamic list from step 204 to FPGA 154a-c. In an embodiment, program 150 transmits the PCIe address, and firmware image size associated with maintained firmware image. In an embodiment, program 150 only transmits information associated with firmware images that have a firmware image size less than a respective memory size of FPGA 154a-c.

Program 150 transmits firmware image download command to FPGA (step 208). In an embodiment, responsive to a user indication or a change in one or more firmware, program 150 transmits a download command to FPGA 154a-c, indicating that the maintained firmware images 152 are available to downloading and subsequent flashing. In an embodiment, program 150 transmits the download command to start a download of firmware images 152.

Program 150 releases allocated memory (step 210). In an embodiment, responsive to an indication that all FPGAs (i.e., FPGA 154a-c) have completed downloading and flashing firmware images 152, program 150 releases any memory allocated to firmware images 152, allowing other computational processes to utilize the freed memory, thus increasing computational efficiency of the system.

FIG. 3 depicts flowchart 300 illustrating operational steps of program 150 for updating firmware on a FPGA, in accordance with an embodiment of the invention. The steps contained in FIG. 3 are executed on one or more FPGA 154a-c.

Program 150 determines FPGA type and associated firmware image (step 302). In an embodiment, responsive to a received download command, program 150 determines a respective FPGA type associated with FPGA 154a-c, where the FPGA type maps to a respective firmware image. In an embodiment, program 150 determines the FPGA type through an indication of type from a user. In another embodiment, program 150 determines the FPGA type based on an architecture or infrastructure of the respective FPGA or a system comprising FPGA 154a-c. For example, program 150 determines a purpose of the respective FPGA within an overall system dedicated to a specific application (e.g., radar application (parallel processing infrastructure), unmanned aerial vehicle (sensor processing and communication infrastructure), industrial control system (automation and encryption infrastructure), data centers (network and storage infrastructure)).

Program 150 determines PCIe address and image size (step 304). In an embodiment, program 150 determines a PCIe address and image size of firmware images 152 from the transmitted download command. In an embodiment, if the firmware image size is greater than a capacity associated with the FPGA, then program 150 requests a new mapped firmware image with an appropriate image size.

Program 150 downloads a firmware image into FPGA memory (step 306). In an embodiment, responsive to a determined PCIe address and firmware image size, program 150 downloads a corresponding firmware image into FPGA 154a, 154b, and/or 154c. For example, program 150 downloads a mapped firmware image utilizing the PCIe address and stores the firmware image in flash memory associated with FPGA 154a, 154b, and/or 154c. In an embodiment, responsive to a downloaded firmware image, program 150 updates or flashes FPGA 154a, 154b, and/or 154c with the downloaded firmware image. In another embodiment, responsive to a flashed FPGA 154a, 154b, and/or 154c, program 150 marks FPGA 154a, 154b, and/or 154c as ready for subsequent computational activities or applications.

Program 150 transmits indication of firmware completion (step 308). In an embodiment, responsive to firmware flash completion, implementation and/or verification, program 150 transmits an indication of completion to the system allocating memory associated with firmware images 152.

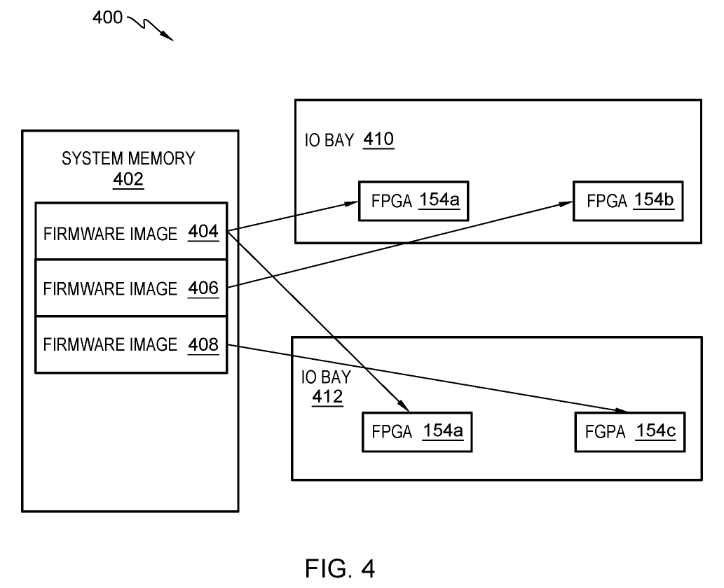

FIG. 4 depicts illustration 400, in accordance with an illustrative embodiment of the invention. Illustration 400 comprises system memory 402 containing firmware image 404-408; IO bay 410 and IO bay 412, respectively containing FPGA 154a/FPGA 154b and FPGA 154a/FPGA 154c. Firmware image 404 is mapped to a FPGA type associated with FPGA 154a, firmware image 406 is mapped to a FPGA type associated with FPGA 154b, and firmware image 408 is mapped to a FPGA type associated with FPGA 154c. In illustration 400, program 150 allocates memory for firmware image 404-408 and provides DMA to the allocated memory for FPGA 154a-c. Program 150 then determines the respective type of FPGA of FPGA 154a-c and responsively maps each FPGA to a specific firmware image. Responsively, FPGA 154a-c downloads and flashes a respectively mapped firmware image. Responsively, program 150 frees system memory associated with firmware image 404-408.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
allocating, by a firmware update manager, system memory for one or more firmware images based on respective firmware image size;
reading, by the firmware update manager, the one or more firmware images into the allocated system memory;
input/output (IO) mapping, by the firmware update manager, each firmware image from the allocated system memory such that peripheral component interconnect express (PCIe) devices have direct memory access (DMA) to each of the one or more firmware images;
transmitting, by the firmware update manager, a PCIe address and a firmware image size to one or more respective field-programmable gate arrays (FPGAs); and
updating the one or more respective FPGAs with the one or more firmware images utilizing the respective PCIe address.

2. The computer-implemented method of claim 1, further comprising:
transmitting, by the firmware update manager, a download command to the one or more respective FPGAs to start a respective firmware image download.

3. The computer-implemented method of claim 2, wherein updating the one or more respective FPGAs with the one or more firmware images utilizing the respective PCIe address, comprises:
determining a respective type for each of the one or more respective FPGAs; and
determining the respective PCIe address, and the respective firmware image size mapped to the respective type for the one or more respective FPGAs.

4. The computer-implemented method of claim 3, furthering comprising:
responsive to the download command, downloading a respective firmware image using the respective PCIe address and the respective firmware image size to a respective flash memory of the one or more respective FPGAs.

5. The computer-implemented method of claim 1, furthering comprising:
maintaining, by the firmware update manager, a dynamic list of each firmware image with the respective system memory address, the respective PCIe address, and the respective firmware image size.

6. The computer-implemented method of claim 1, further comprising:
indicating to the firmware update manager that the one or more respective FPGAs have completed a firmware download.

7. The computer-implemented method of claim 6, further comprising:
responsive to an indication that each of the one or more FPGAs have completed the firmware download, releasing, by the firmware update manager, the allocated system memory.

8. A computer program product comprising:
one or more computer readable storage media having computer-readable program instructions stored on the one or more computer readable storage media, said program instructions executes a computer-implemented method comprising steps of:
allocating, by a firmware update manager, system memory for one or more firmware images based on respective firmware image size;
reading, by the firmware update manager, the one or more firmware images into the allocated system memory;
input/output (IO) mapping, by the firmware update manager, each firmware image from the allocated system memory such that peripheral component interconnect express (PCIe) devices have direct memory access (DMA) to each of the one or more firmware images;
transmitting, by the firmware update manager, a PCIe address and a firmware image size to one or more respective field-programmable gate arrays (FPGAs); and
updating the one or more respective FPGAs with the one or more firmware images utilizing the respective PCIe address.

9. The computer program product of claim 8, wherein the program instructions, stored on the one or more computer readable storage media, further comprise the steps of:
transmitting, by the firmware update manager, a download command to the one or more respective FPGAs to start a respective firmware image download.

10. The computer program product of claim 9, wherein the program instructions to update the one or more respective FPGAs with the one or more firmware images utilizing the respective PCIe address, stored on the one or more computer readable storage media, comprise the steps of:
determining a respective type for each of the one or more respective FPGAs; and
determining the respective PCIe address, and the respective firmware image size mapped to the respective type for the one or more respective FPGAs.

11. The computer program product of claim 10, wherein the program instructions, stored on the one or more computer readable storage media, further comprise the steps of:
responsive to the download command, downloading a respective firmware image using the respective PCIe address and the respective firmware image size to a respective flash memory of the one or more respective FPGAs.

12. The computer program product of claim 8, wherein the program instructions, stored on the one or more computer readable storage media, further comprise the steps of:
maintaining, by the firmware update manager, a dynamic list of each firmware image with the respective system memory address, the respective PCIe address, and the respective firmware image size.

13. The computer program product of claim 8, wherein the program instructions, stored on the one or more computer readable storage media, further comprise the steps of:
indicating to the firmware update manager that the one or more respective FPGAs have completed a firmware download.

14. The computer program product of claim 13, wherein the program instructions, stored on the one or more computer readable storage media, further comprise the steps of:
responsive to an indication that each of the one or more FPGAs have completed the firmware download, releasing, by the firmware update manager, the allocated system memory.

15. A computer system comprising:
one or more computer processors;
one or more computer readable storage media having computer readable program instructions stored on the one or more computer readable storage media for execution by at least one of the one or more processors, the stored program instructions execute a computer-implemented method comprising steps of:
allocating, by a firmware update manager, system memory for one or more firmware images based on respective firmware image size;
reading, by the firmware update manager, the one or more firmware images into the allocated system memory;
input/output (IO) mapping, by the firmware update manager, each firmware image from the allocated system memory such that peripheral component interconnect express (PCIe) devices have direct memory access (DMA) to each of the one or more firmware images;
transmitting, by the firmware update manager, a PCIe address and a firmware image size to one or more respective field-programmable gate arrays (FPGAs); and
updating the one or more respective FPGAs with the one or more firmware images utilizing the respective PCIe address.

16. The computer system of claim 15, wherein the program instructions stored on the one or more computer readable storage media, further comprise the steps of:
transmitting, by the firmware update manager, a download command to the one or more respective FPGAs to start a respective firmware image download.

17. The computer system of claim 16, wherein the program instructions to update the one or more respective FPGAs with the one or more firmware images utilizing the respective PCIe address, stored on the one or more computer readable storage media, comprise the steps of:
determining a respective type for each of the one or more respective FPGAs; and
determining the respective PCIe address, and the respective firmware image size mapped to the respective type for the one or more respective FPGAs.

18. The computer system of claim 15, wherein the program instructions stored on the one or more computer readable storage media, further comprise the steps of:
maintaining, by the firmware update manager, a dynamic list of each firmware image with the respective system memory address, the respective PCIe address, and the respective firmware image size.

19. The computer system of claim 15, wherein the program instructions stored on the one or more computer readable storage media, further comprise the steps of:
indicating to the firmware update manager that the one or more respective FPGAs have completed a firmware download.

20. The computer system of claim 19, wherein the program instructions stored on the one or more computer readable storage media, further comprise the steps of:
responsive to an indication that each of the one or more FPGAs have completed the firmware download, releasing, by the firmware update manager, the allocated system memory.
